(19) United States
(12) Patent Application Publication
(10) Pub. No.: US 2026/0158976 A1
(43) Pub. Date: Jun. 11, 2026

(54) CHILD CAR SEAT BELT GUIDE

(71) Applicant: Evenflo Company, Inc., Miamisburg, OH (US)

(72) Inventors: Bryan Ray ADAMS, Beavercreek, OH (US); Guy Dingman, Idaville, IN (US); Jason Mcroberts, Mason, OH (US)

(21) Appl. No.: 18/976,632

(22) Filed: Dec. 11, 2024

(51) Int. Cl. B60N 2/28

(52) U.S. Cl. CPC B60N 2/2806; B60N 2/2821

(57) ABSTRACT

Embodiments of the present disclosure include a car seat comprising a base and a seat shell. The base comprises a receiving portion and a backing portion, wherein the backing portion further comprises a belt guide. The belt guide comprises a slot opening, a slot, and a belt channel that extends between a rear surface and a forward surface of the backing portion. A belt pathway extends from the rear surface to the opposite forward surface through the belt channel such that a seat belt extends through the belt channel from the rear surface to the opposite forward surface.

### BACKGROUND

In the United States, child car seats are required by law and recommended for children of certain ages or sizes. There are many types of car seats available for purchase. Infant car seats recommended for children under the age of one are typically rearward facing. Many infant car seats include a base that is belted or tethered into the car and a seat that may latch into the base. Some car seats, including rotatable car seats, have a seat shell that holds the child occupant and a base supporting the seat shell.

### BRIEF DESCRIPTION OF THE DRAWINGS

The foregoing and other features of the present disclosure will become more fully apparent from the following description and appended claims, taken in conjunction with the accompanying drawings. Understanding that these drawings depict several examples in accordance with the disclosure and are, therefore, not to be considered limiting of its scope, the disclosure is described with additional specificity and detail below through the use of the accompanying drawings.

FIG. 1 is a side view of a car seat, in accordance with an embodiment disclosed herein;

FIGS. 2 and 3 are side views of the base of FIG. 1, in accordance with an embodiment disclosed herein;

FIG. 4 is a front view of a base of FIG. 1 in accordance with an embodiment disclosed herein;

FIG. 5 is a close-up front view of a base of FIG. 1, in accordance with an embodiment disclosed herein;

FIG. 6 is a close-up view of the base of FIG. 1, in accordance with an embodiment disclosed herein;

FIG. 7 is a rear view of the base of FIG. 1, in accordance with an embodiment disclosed herein;

FIG. 8 is a close-up rear view of the base of FIG. 1, in accordance with an embodiment disclosed herein;

FIG. 9 is a close-up cross-sectional view of the base of FIG. 1, in accordance with an embodiment disclosed herein;

FIG. 10 is a close-up cross-sectional view of the base of FIG. 1, in accordance with an embodiment disclosed herein;

FIG. 11 is a view of the base of FIG. 1, in accordance with an embodiment disclosed herein; and

FIG. 12 is a top-down view of the base of FIG. 1, in accordance with an embodiment disclosed herein.

### DETAILED DESCRIPTION

In the following detailed description, reference is made to the accompanying drawings, which form a part hereof. In the drawings, similar symbols identify similar components, unless context dictates otherwise. The illustrative examples described in the detailed description and drawings are not meant to be limiting and are for explanatory purposes. Other examples may be utilized, and other changes may be made, without departing from the spirit or scope of the subject matter presented herein. It will be readily understood that the aspects of the present disclosure, as generally described herein and illustrated in the drawings, may be arranged, substituted, combined, and designed in a wide variety of different configurations, each of which are explicitly contemplated and form a part of this disclosure.

Juvenile car seats, as will be discussed below in greater detail, provide a secure seating option for children in a vehicle. A juvenile car seat may be able to rotate relative to a base secured to the vehicle. The rotation of a seat portion relative to the base allows the seat to be forward facing, rearward facing, and at intermediate positions there between.

In some configurations the juvenile car seat may be rear facing in the vehicle. In this configuration, the occupant of the juvenile car seat, a child, is facing the seat back of the vehicle seat to which the juvenile car seat is secured. In this orientation the child may access the vehicle's seat belt, such as a shoulder belt portion of the vehicle seat belt, with their hands or feet in some situations. For example, when the shoulder belt portion of the vehicle's seat belt is leveraged to secure a base of the juvenile car seat to the vehicle, the shoulder portion of the seat belt crosses between the base and the child. In this configuration, the child may attempt to entangle their feet, for example, in the shoulder belt portion. An ability to limit a perception of a child's ability to entangle their feet with the shoulder belt is desired.

As will be provided in greater detail hereinafter the following disclosure provides for a belt pathway integrated into a base of the juvenile car seat. The belt pathway provides, in an example, a securement option for a rotating juvenile car seat to a vehicle. The belt pathway includes, in an example, a slot opening at a top side of a base to which a seat is rotatably attached. The slot opening allows access into a slot that extends from the top side downwardly in the base. The slot transitions into a belt channel that also extends between a rear surface and a forward surface of the base. Because the seat portion rotates relative to the base in an example, the belt pathway is offset from a midline of the base. In an example, the belt channel is on a medial side (e.g., a side more towards a middle of the vehicle to which it is secured than a lateral side) of the midline. This medial side positioning minimizes a distance across the base front side to which a child can interact with the seat belt. Additionally, in an example a belt cover cantilevered from the front of the base also allows for ease of installation while further limiting a child's ability to interact with the seat belt. Additional structures and features are provided below to improve the installation of a juvenile car seat in a vehicle with a seat belt securement.

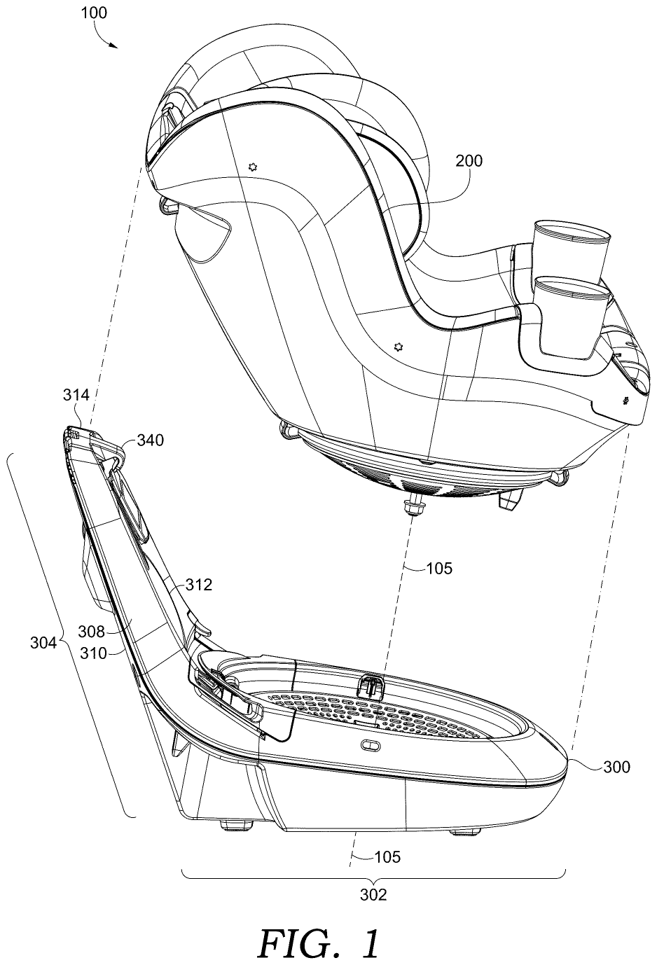

In accordance with aspects of the disclosure, exemplary embodiments of car seats are illustrated in various levels of specificity in FIGS. 1-12. As will be appreciated by those skilled in the art, the car seats described herein may be convertible car seats that are convertible between at least two configurations. For example, a car seat described herein may be convertible between a forward-facing configuration and a rearward-facing configuration. The car seats of the present disclosure may be configured to support an infant, child, toddler, or the like.

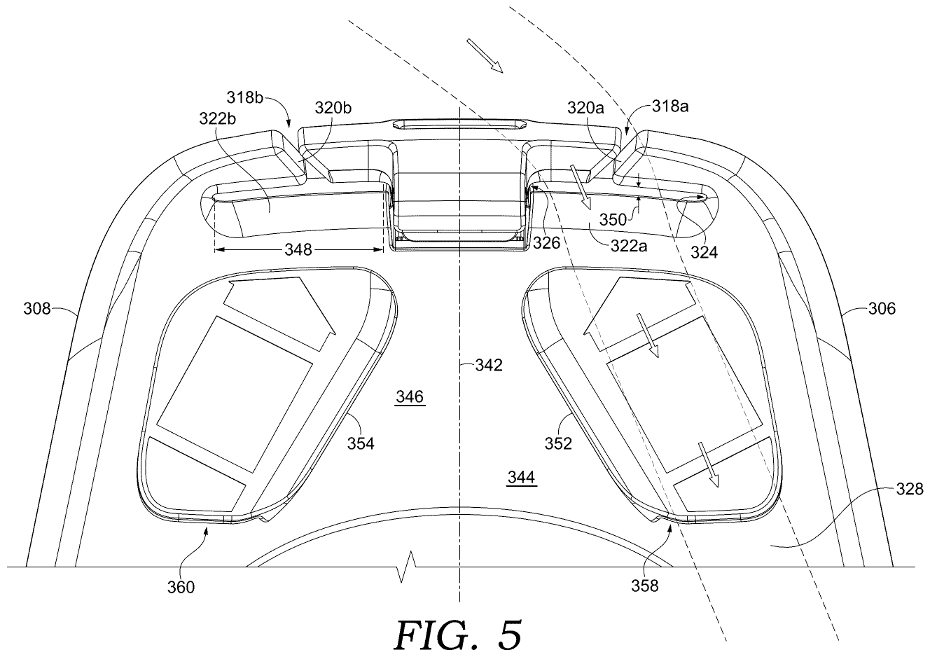

Very generally, FIGS. 1-12 depict a car seat 100 designed for transporting an infant or child in a vehicle, such as a car. The car seat 100 generally includes a seat shell 200 and a base 300 that supports the seat shell 200 in a vehicle. The car seat 100 (and, namely, the base 300) may be affixed to the seat of a vehicle, such as by a vehicle belt (e.g., seat belt) extending through a belt pathway 328 (see FIG. 5). As described herein, a seat belt may include an upper portion that extends across an occupant's chest and a lower portion that extends across an occupant's lap. As will be apparent, the upper portion of the seat belt is described herein as being routed through belt guides on the car seat base 300.

In aspects, the seat shell 200 may be rotatable relative to the base 300. In this way, the seat shell 200 may be rotated to be selectively positionable in a variety of different positions (e.g., a rearward-facing position, a forward-facing position, an intermediate loading position) when installed in a vehicle. In particular, the seat shell 200 may rotate about an axis 105 that may be generally vertical. In some examples, the axis 105 is generally vertical while on a slight diagonal such that the angle of the seat shell 200 relative to the vehicle seat may change as the seat shell 200 is rotated about the axis 105 between forward-facing and rearward-facing positions.

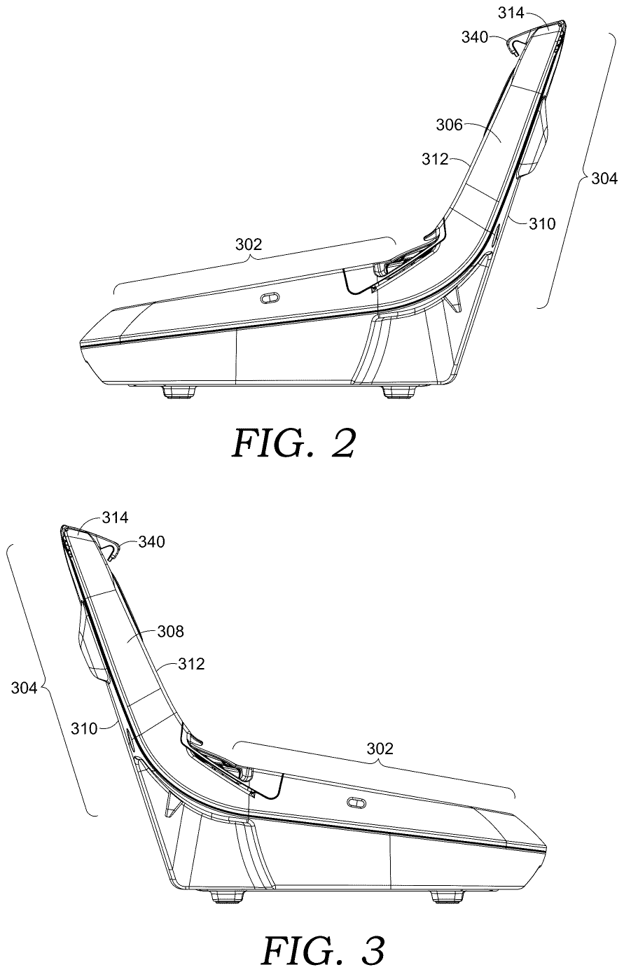

FIG. 1 illustrates an exploded side view of the car seat 100 system including the seat shell 200 and the base 300. The base includes a receiving portion 302 for receiving the seat shell 200 and a backing portion 304 extending upwards from the receiving portion 302. The backing portion 304, as shown in FIGS. 1-4 comprises a first side 306, a second side 308 (opposite the first side 306), a rear surface 310, an opposite forward surface 312, a top side 314, and a receiving feature 340. FIG. 2 provides a side view of the first side 306 of the base 300 and FIG. 3 provides a side view of the second side 308 of the base 300.

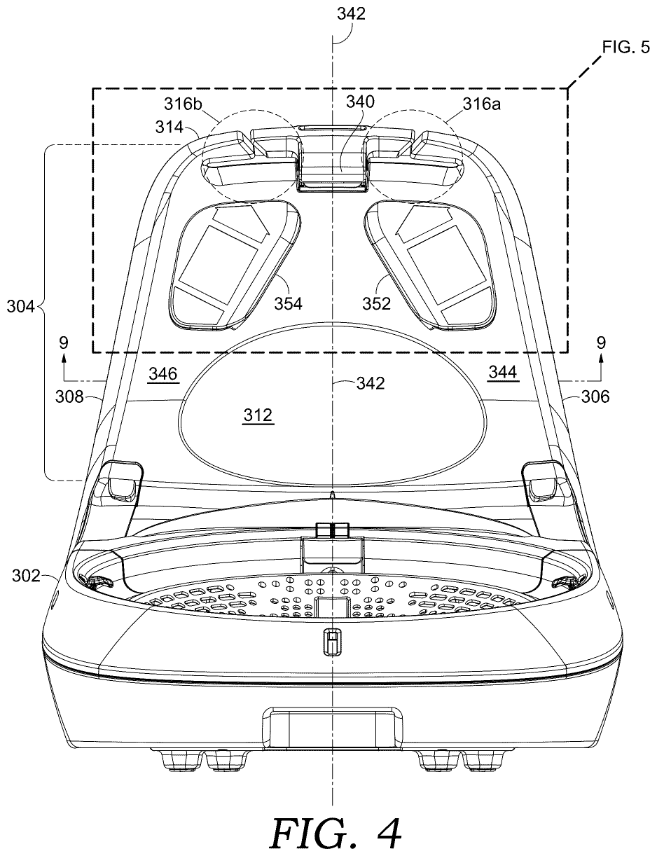

FIG. 4 provides a front view of the base 300 having a reference midline 342. The reference midline 342 is equidistant between the first side 306 and the second side 308. The reference midline 342 is provided herein for illustration purposes only and does not physically exist. It is merely a reference to aid in the description of the base 300 structure.

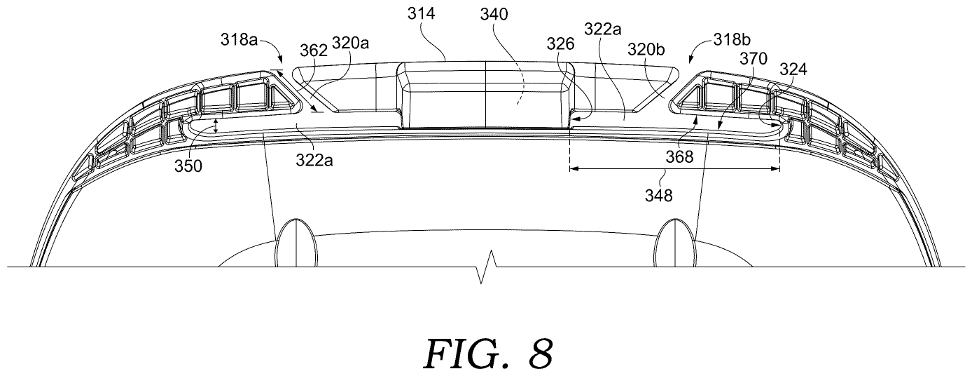

The receiving feature 340 on the base 300 may receive a corresponding feature of the seat shell 200 to help retain the seat shell 200 on the base 300. By way of a non-limiting example, the receiving feature 340 is a downward-facing hook. In other examples, the base 300 may have receiving features that form a slot or groove or an upward-facing hook for receiving/interfacing with the seat shell 200. In aspects, at least a portion of the receiving feature 340 extends between a bottom end 370 of the belt channel and the top side 314 of the base 300, as illustrated in FIG. 8. In other words, the belt channel (either belt channel 322a or 322b) undercuts at least a portion of the receiving feature 340.

Continuing on, the top side 314, as shown in FIG. 4, comprises one or more belt guides such as belt guide 316a and belt guide 316b, which are provided in an enlarged view in FIG. 5. The belt guides are provided to aid in securing the base 300 to a vehicle via a vehicle seat belt, such as a shoulder belt portion of the seat belt. A vehicle seat belt also generally includes a lap belt portion. The vehicle car seat belt typically transitions from the lap belt portion to the shoulder belt portion at a fastener, such as a seat belt buckle. Car seat bases are sometimes installed with a shoulder belt portion of a seat belt behind the backing portion 304 of the base 300 but the installation may be enhanced with the shoulder belt portion extending across the front of the backing portion 304 of the base 300. Aspects herein utilize the belt guides, such as belt guides 316a and 316b, to feed a shoulder belt portion of a seat belt to a forward side of the backing portion 304 of the base 300 for additional support.

Further reference herein to the belt guides may be made to either the belt guide 316a or the belt guide 316b in isolation for brevity and is not meant to limit the scope of the description. The features described herein with respect to the belt guide 316a are equally applicable to the belt guide 316b as they mirror one another. Both are located on the top side 314 of the backing portion 304 and on either side of the reference midline 342. Specifically, the belt guide 316a is located on a first side 344 of the reference midline 342 while the belt guide 316b is located on a second side 346 of the reference midline 342. Depending on a side of the vehicle the car seat 100 is installed, the belt guide 316a or 316b will be selected. In an example, if the car seat 100 is installed on a passenger's side of the vehicle the belt guide 316a will be leveraged. In another example, if the car seat 100 is installed on a driver's side of the vehicle the belt guide 316b will be leveraged. It is contemplated that the belt guide 316a and 316b will be selected based on an opposite relative side of the midline 342 to the side of the vehicle (e.g., left side of the vehicle installation will use the right side of the midline and the right side of the vehicle installation will use the left side of the midline).

As shown in the enlarged view of FIG. 5, the belt guide 316a comprises a slot opening 318a on the top side 314 of the backing portion 304. The slot opening 318a is a cavity-type space or void in the top side 314 that extends downward toward the receiving portion 302 resulting in a channel, referred to herein as a slot 320a, and extends between the forward surface 312 to the rear surface 310. The slot 320a is a channel, which may be in a general vertical orientation, extending from the slot opening 318a on the top side 314 to a belt channel 322a. In aspects, the slot 320a is biased at an inward angle toward the reference midline 342 as it extends from the slot opening 318a on the top side 314 to the belt channel 322a. Both the slot 320a and the belt channel 322a extend between the rear surface 310 and the forward surface 312. In other aspects, the slot 320a is a general vertical orientation that is substantially parallel to the reference midline 342.

Similarly, the belt guide 316b comprises a slot opening 318b on the top side 314 of the backing portion 304. The slot opening 318b is a cavity-type space or void in the top side 314 that extends downward toward the receiving portion 302 resulting in a channel, referred to herein as a slot 320b. The slot 320b is a vertical channel extending from the slot opening 318b on the top side 314 to a belt channel 322b. The slot 320b is biased at an inward angle toward the reference midline 342 as it extends from the slot opening 318b to the belt channel 322b. Both the slot 320b and the belt channel 322b extend between the rear surface 310 and the forward surface 312.

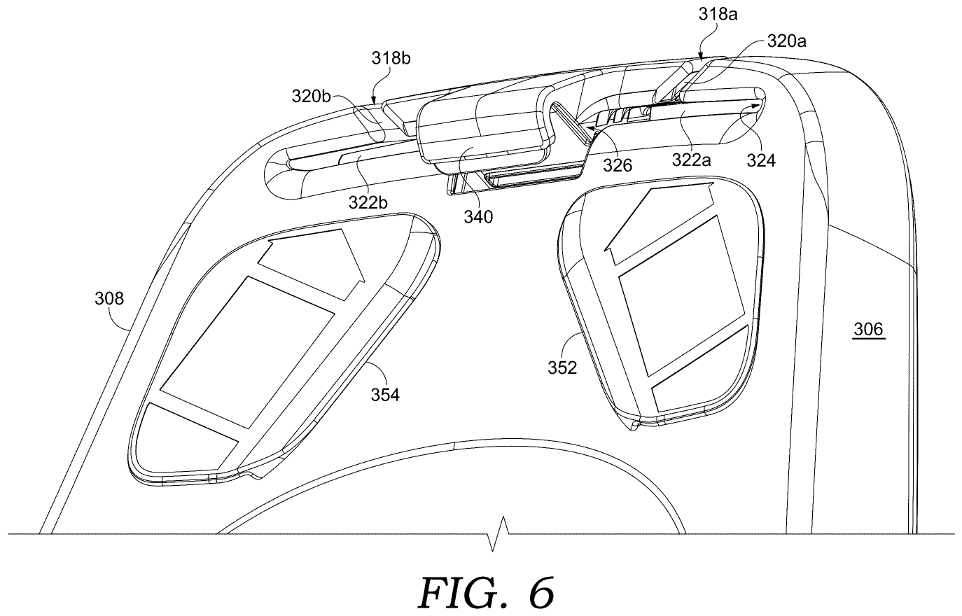

As further illustrated in FIGS. 5 and 6, a seat belt of a vehicle is routed from an originating point (e.g., a fixed point in a vehicle) through a belt guide to be secured in a fastening end point (i.e., the seat belt buckle of a vehicle). For example, FIG. 5 is a front plan enlarged view of a portion of the backing portion 304 of the base 300 while FIG. 6 offers a front enlarged view of the same area of FIG. 5. If the base 300 is present on a passenger side of the vehicle and in a forward-facing orientation (i.e., the forward surface 312 is facing toward the forward end of a vehicle when installed), then a seat belt would originate from the passenger side of the vehicle on the second side 308 of the base 300. As shown, a seat belt extends from the rear surface 310 on the second side 308 through the belt channel 322a on the first side 306 to the forward surface 312 of the base 300 to create a belt pathway 328. If, for instance, the base 300 were installed in a back seat of a vehicle on a driver's side, a seat belt would originate from the rear surface 310 on the first side 306 of the base 300 and extend through belt channel 322b on the second side 308 of the base (opposite of the seat belt origination) to the forward surface 312 of the base 300.

Belt pathways, in aspects, extend from the rear surface 310 to the opposite forward surface 312 through the belt channels (e.g., belt channel 322a or belt channel 322b). Furthermore, the belt pathway 328 extends exclusively on a single side on the forward surface 312 of the base 300. The belt pathway 328 illustrated herein is in reference to the upper portion of a seat belt that is typically extended across a chest of an occupant or across the base 300 of a car seat.

As described in the examples above and illustrated in FIG. 5, if the seat belt extends through belt channel 322a (on the first side 306) then it continues exclusively on the first side 344 of the reference midline and does not cross the reference midline 342 on the forward surface 312. The belt pathway 328 originates from a side opposite of the belt guide utilized such that the belt pathway 328 crosses the reference midline on the rear surface 310 (i.e., when the seat belt originates on a passenger side or second side 308, it extends from the second side 346 of the reference midline 342 on the rear surface 310 to the first side 344 of the reference midline 342 on the rear surface 310, through the belt guide 316a on the first side 344 of the reference midline 342, and extends exclusively on the first side 344 of the reference midline 342 on the forward surface 312). Thus, a belt pathway 328 originating on a driver side of a vehicle will start on a first side 306 on the rear surface 310 (i.e., the first side 344 of the reference midline 342), cross the reference midline 342 to extend through the belt guide 316b on the second side 308, and continue extending on the forward surface 312 only on the second side 346 of the reference midline 342.

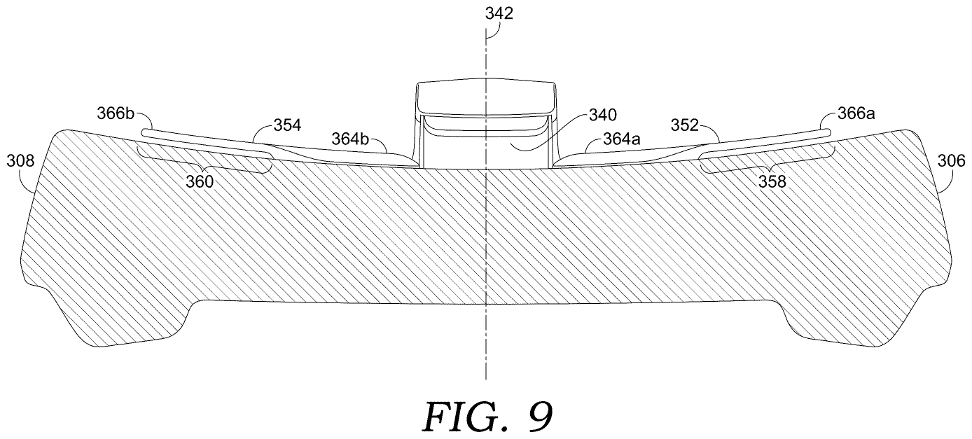

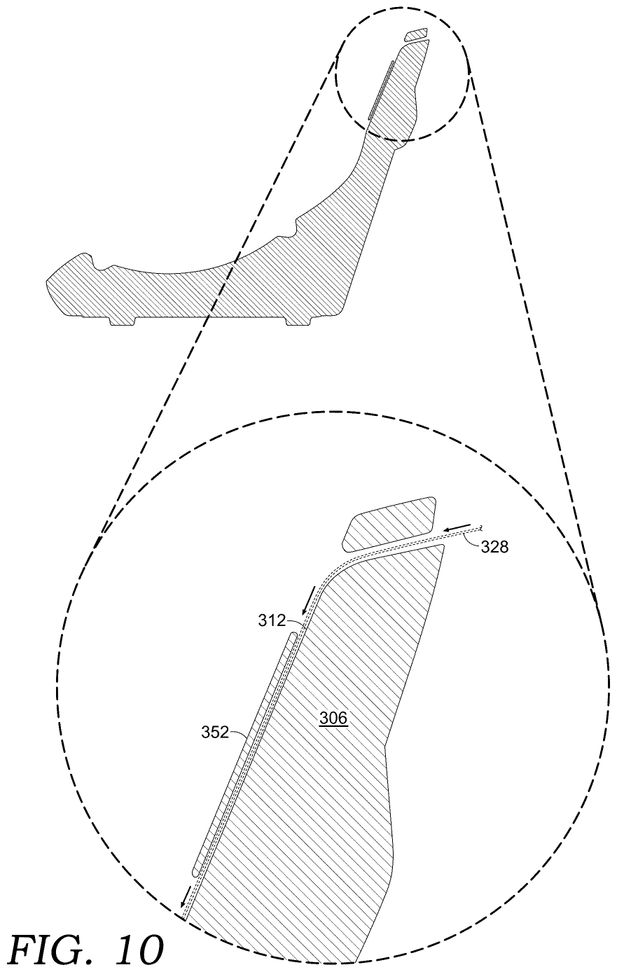

As the belt pathway 328 extends on the forward surface 312, a mechanism to cover the seat belt is provided. As can be imagined, when the car seat 100 is in a rear-facing orientation, a child's legs/feet are proximate to the forward surface 312 of the base 300. Thus, the belt pathway 328 is accessible to a child occupant. To avoid access to the belt pathway 328, the backing portion 304 further comprises one or more belt covers, shown as first belt cover 352 and second belt cover 354, on the forward surface 312. In aspects, the belt covers are cantilevered away from the reference midline 342 of the forward surface 312, as is visible in FIG. 6 and cross-sectional views of FIGS. 9 and 10. In other aspects, the belt covers are cantilevered toward the reference midline 342 of the forward surface 312. The belt covers enclose/cover the seat belt as it extends on the forward surface 312. In aspects, the belt pathway 328 extends on the forward surface 312 such that it lies between the forward surface 312 and the first belt cover 352 (or between the forward surface 312 and the second belt cover 354). For instance, a seat belt extending over the first side 344 of the reference midline 342 on the forward surface 312 would be covered/obscured by the first belt cover 352 while a seat belt extending on the second side 346 of the reference midline 342 on the forward surface 312 would be obscured by the second belt cover 354. This ensures that seat belts are flush with the base 300 and child seat occupants are not able to entrap their feet and/or legs within the seat belt as they could if the seat belt were accessible. Rather, a seat belt is enclosed against the forward surface 312 at least for a portion of the belt pathway 328 extending from the belt guide (either belt guide 316a or 316b) to an end of the first belt cover 352 or second belt cover 354.

FIGS. 9 and 10 are cross-section views provided to better illustrate the cantilevered positioning of the belt covers. FIG. 9 provides a bottom-up cross-sectional view of the first belt cover 352 on the first side 306 and the second belt cover 354 on the second side 308. As shown, the first belt cover 352 comprises a first end 364a near the reference midline 342 and a second end 366a away from the reference midline. The first belt cover 352 is cantilevered away from the reference midline 342 such that the first end 364a is in direct contact with the forward surface 312 while the second end 366a is not in direct contact with the forward surface 312. Rather, a gap exists between the second end 366a and the forward surface 312. In aspects, the gap is 2 millimeters. The gap is a sufficient size to allow a seat belt to slide through the gap in a flat orientation and not twist on itself. A first portion 358 of the forward surface 312 is obscured by the first belt cover 352. FIG. 10 illustrates a belt pathway 328 that extends downward toward the receiving portion 302 between the forward surface 312 of the first side 306 and the first belt cover 352.

Similarly, returning to FIG. 9, the second belt cover 354 comprises a first end 364b near the reference midline 342 and a second end 366b away from the reference midline. The second belt cover 354 is cantilevered away from the reference midline 342 such that the first end 364b is in direct contact with the forward surface 312 while the second end 366b is not in direct contact with the forward surface 312. Rather, a gap exists between the second end 366b and the forward surface 312. In aspects, the gap is 2 millimeters. A second portion 360 of the forward surface 312 is obscured by the second belt cover 354.

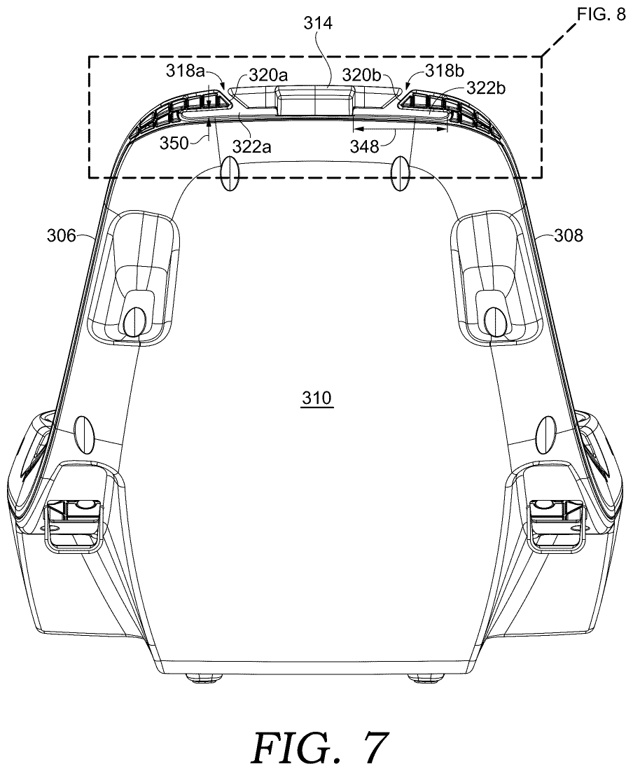

Turning now to FIG. 7, a rear view of the base 300 is provided. The rear surface 310 is visible as well as the first side 306 and the second side 308. The top side 314 including the belt guide 316a and the belt guide 316b is enlarged and illustrated in FIG. 8. As shown in FIG. 8 (as well as FIG. 5), a belt channel comprises a width 348 and a height 350. The width 348 extends from a first end 324 to a second end 326 of the belt channel 322a and is as least as wide as a standard seat belt such that the seat belt is flat within the belt channel 322a and not twisted. In aspects, the width 348 of a belt channel, is greater than the height 350 of a belt channel. In aspects, the width 348 is two times or more greater than the height 350. In some aspects, the width 348 of a belt channel is between 1.5 inches and 4 inches. Similarly, each slot (slot 320a and 320b) comprises a slot height 362. In aspects, the slot height 362 is greater than the height 350 of the belt channel 322a (or 322b). The slot height 362 may be smaller than 4 times the height 350 of the belt channel 322a (or 322b). Additionally, while the height 350, the width 348, and the slot height 362 are only shown with respect to a single belt guide for clarity, the descriptions of the heights and widths apply equally to each of belt guide 316a and belt guide 316b.

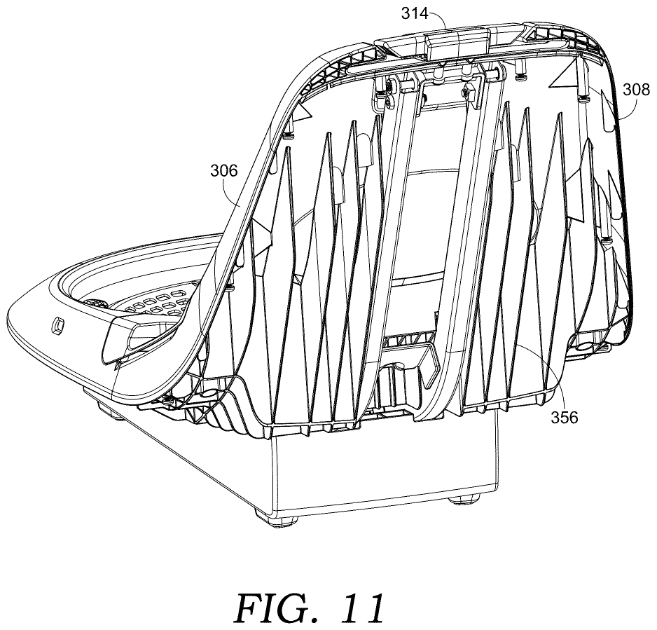

Turning now to FIG. 11, an additional rear view of the base 300 is provided where a plurality of support structures 356 are shown extending across the base 300 from the first side 306 to the second side 308 and extending from the top side 314 toward the receiving portion 302. The support structures 356 are vertical rigid pieces provided to stabilize the base 300 and are positioned between the rear surface 310 and the forward surface 312.

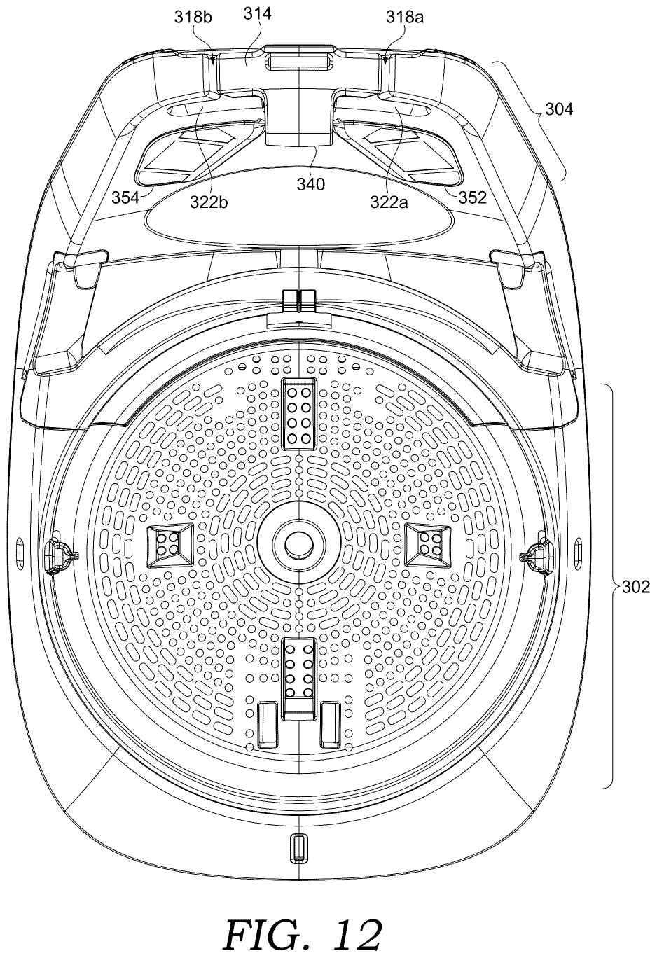

FIG. 12 provides a top-down view of the base 300. As is shown, the backing portion 304 extends upwards from the receiving portion 302. Of particular note in FIG. 12, the top side 314 is visible as well as the slot opening 318a and the slot opening 318b such that the slot openings 318a and 318b are illustrated as voids or empty space within the top side 314 that extend from the forward surface 312 to the rear surface 310.

It should be noted that some of the terms used herein may be relative terms. For example, the terms “upper” and “lower” and the terms “forward” (or “front”) and “rearward” (or “back”) are relative to each other in location, i.e., an upper component is located at a higher elevation than a lower component in a given orientation, but these terms may change if the device is flipped. An intermediate component, on the other hand, is always located between an upper component and a lower component regardless of orientation. The terms “horizontal” and “vertical” are used to indicate direction relative to an absolute reference, i.e., ground level. However, these terms should not be construed to require structures to be absolutely parallel or absolutely perpendicular to each other. For example, a first vertical structure and a second vertical structure are not necessarily parallel to each other. The terms “top” and “bottom” are used to refer to surfaces where the top is always higher than the bottom relative to an absolute reference, i.e. the surface of the earth when the component is used as intended. The terms “upwards” or “upwardly” and “downwards” or “downwardly” are also relative to an absolute reference; upwards is always against the gravity of the earth. The terms “forward” and “rearward” or “rear” with respect to a position or orientation are opposite one another along a common direction, and an “intermediate” position is always located between a forward position and a rearward position.

The terms “operative to” and “configured to” and similar terms are used herein to describe that a particular component has certain structural features designed to perform a designated function. Such components should be construed as having the expressed structure, with the designated function being considered part of the structure. The term “engage” and similar terms are used herein to describe the interaction between particular components and do not necessarily require that such components contact one another (directly or indirectly). As used herein and as will be appreciated by those skilled in the art, the term “car seat” encompasses car seats, safety seats, restraints, boosters, and the like for children, infants, toddlers, and the like.

The following clauses represent example embodiments of concepts contemplated herein. Any one of the following clauses may be combined in a multiple dependent manner to depend from one or more other clauses. Further, any combination of dependent clauses (clauses that explicitly depend from a previous clause) may be combined while staying within the scope of aspects contemplated herein. The following clauses are examples and are not limiting.

Clause 1. A car seat comprising: a seat shell; a base, wherein the base comprises a receiving portion and a backing portion, the backing portion having a first side, an opposite second side, and a top side between the first side and the opposite second side, the backing portion further comprising a rear surface and an opposite forward surface, wherein the backing portion further comprises a belt guide, wherein the belt guide comprises: a slot opening at the top side, a slot, and a belt channel extending between the rear surface and the forward surface.

Clause 2: The car seat of clause 1, wherein the seat shell is rotatable relative to the base.

Clause 3: The car seat of any of clauses 1-2, wherein the base further comprises a receiving feature.

Clause 4: The car seat of clause 3, wherein the receiving feature is a downward-oriented hook

Clause 5: The car seat of any of clauses 1-4, wherein the belt channel comprises a first end and a second end, and wherein at least a portion of the receiving feature extends between the second end and the top side of the base.

Clause 6: The car seat of any of clauses 1-5, wherein a belt pathway extends from the rear surface to the opposite forward surface through the belt channel.

Clause 7: The car seat of any of clauses 1-6, wherein the base includes a reference midline equidistant between the first side and the second side, and wherein the belt channel is on a first side of the reference midline.

Clause 8: The car seat of clause 7, wherein a belt pathway extends exclusively on the first side of the reference midline on the forward surface.

Clause 9: The car seat of clause 7, wherein a belt pathway extends from a second side of the reference midline to the first side of the reference midline on the rear surface and through the belt channel and continues exclusively on the first side of the reference midline on the forward surface.

Clause 10: The car seat of clause 7, wherein the slot, as it extends from the slot opening to the belt channel, is biased at an inward angle toward the reference midline of the base.

Clause 11: The car seat of any of clauses 1-10, wherein a width of the belt channel is greater than a height of the belt channel.

Clause 12: The car seat of any of clauses 1-10, wherein a width of the belt channel is between 1.5 inches and 4 inches.

Clause 13: The car seat of any of clauses 1-10, wherein the base further comprises a first belt cover and a second belt cover.

Clause 14: The car seat of clause 13, wherein a belt pathway extends between the front surface and the first belt cover.

Clause 15: A car seat comprising: a seat shell; and a base, wherein the base comprises a receiving portion and a backing portion, the backing portion having a first side, an opposite second side, and a top side between the first side and the opposite second side, the backing portion further comprising a rear surface and an opposite forward surface, wherein the backing portion further comprises a reference midline equidistant between the first side and the second side, wherein the opposite forward surface comprises a first belt cover at least partially obscuring a first portion of the forward surface, wherein the backing portion further comprises a belt guide, wherein the belt guide comprises: a slot opening at the top side, a slot extending from the top side toward the receiving portion, and a belt channel extending between the rear surface and the forward surface, wherein a belt pathway extends from a second side of the reference midline to a first side of the reference midline on the rear surface and through the belt channel and continues on the first side of the reference midline on the forward surface.

Clause 16: The car seat of clause 15, wherein the first belt cover is cantilevered away from the reference midline of the forward surface.

Clause 17: The car seat of any one of clauses 15-16, wherein on the forward surface the belt pathway extends on a same side of the reference midline as the belt channel.

Clause 18: The car seat of any of clauses 15-17, wherein the seat shell is rotatable relative to the base.

Clause 19: The car seat of any of clauses 15-18, wherein a width of the belt channel is greater than a height of the belt channel.

Clause 20: The car seat of any of clauses 15-19, wherein a second belt cover at least partially obscures a second portion of the forward surface and is located on an opposite side of the reference midline from the first belt cover.

While particular exemplary embodiments have been described, it is not intended that the claims be limited thereto, as it is intended that the claims be as broad in scope as the art will allow and that the specification be read likewise. That is, the foregoing description of specific embodiments will so fully reveal the general nature of the disclosure that others may, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It will be appreciated by those of ordinary skill in the art that the components, method steps, and materials illustrated above may be varied by substitution of equivalent components, steps, and materials capable of performing the same functions. It will also be appreciated by one of ordinary skill in the art that sizes and strengths of the components may be scaled up or down as required for specific purposes. The claims hereof are intended to encompass all such equivalent components, method steps and scales.

What is claimed is:

1. A car seat, comprising:
a seat shell; and
a base, wherein the base comprises a receiving portion and a backing portion, the backing portion having a first side, an opposite second side, and a top side between the first side and the opposite second side, the backing portion further comprising a rear surface and an opposite forward surface, wherein the backing portion further comprises a belt guide,
wherein the belt guide comprises:
a slot opening at the top side,
a slot, and
a belt channel extending between the rear surface and the forward surface.

2. The car seat of claim 1, wherein the seat shell is rotatable relative to the base.

3. The car seat of claim 1, wherein the base further comprises a receiving feature.

4. The car seat of claim 3, wherein the receiving feature is a downward-oriented hook.

5. The car seat of claim 4, wherein the belt channel comprises a first end and a second end, and wherein at least a portion of the receiving feature extends between the second end and the top side of the base.

6. The car seat of claim 1, wherein a belt pathway extends from the rear surface to the opposite forward surface through the belt channel.

7. The car seat of claim 1, wherein the base includes a reference midline equidistant between the first side and the second side, and wherein the belt channel is on a first side of the reference midline.

8. The car seat of claim 7, wherein a belt pathway extends exclusively on the first side of the reference midline on the forward surface.

9. The car seat of claim 7, wherein a belt pathway extends from a second side of the reference midline to the first side of the reference midline on the rear surface and through the belt channel and continues exclusively on the first side of the reference midline on the forward surface.

10. The car seat of claim 7, wherein the slot, as it extends from the slot opening to the belt channel, is biased at an inward angle toward the reference midline of the base.

11. The car seat of claim 1, wherein a width of the belt channel is greater than a height of the belt channel.

12. The car seat of claim 1, wherein a width of the belt channel is between 1.5 inches and 4 inches.

13. The car seat of claim 1, wherein the base further comprises a first belt cover and a second belt cover.

14. The car seat of claim 13, wherein a belt pathway extends between the forward surface and the first belt cover.

15. A car seat, comprising:
a seat shell; and
a base, wherein the base comprises a receiving portion and a backing portion, the backing portion having a first side, an opposite second side, and a top side between the first side and the opposite second side, the backing portion further comprising a rear surface and an opposite forward surface, wherein the backing portion further comprises a reference midline equidistant between the first side and the second side, wherein the opposite forward surface comprises a first belt cover at least partially obscuring a first portion of the forward surface, wherein the backing portion further comprises a belt guide,
wherein the belt guide comprises:
a slot opening at the top side,
a slot extending from the top side toward the receiving portion, and
a belt channel extending between the rear surface and the forward surface,
wherein a belt pathway extends from a second side of the reference midline to a first side of the reference midline on the rear surface and through the belt channel and continues on the first side of the reference midline on the forward surface.

16. The car seat of claim 15, wherein the first belt cover is cantilevered away from the reference midline of the forward surface.

17. The car seat of claim 15, wherein on the forward surface the belt pathway extends on a same side of the reference midline as the belt channel.

18. The car seat of claim 15, wherein the seat shell is rotatable relative to the base.

19. The car seat of claim 15, wherein a width of the belt channel is greater than a height of the belt channel.

20. The car seat of claim 15, wherein a second belt cover at least partially obscures a second portion of the forward surface and is located on an opposite side of the reference midline from the first belt cover.
